(19) United States
(12) Patent Application Publication
(10) Pub. No.: US 2013/0047375 A1
(43) Pub. Date: Feb. 28, 2013

(54) ROLLER AND ROLLER DEVICE

(71) Applicant: Kazunori MIYAKE, Kitakatsuragi-gun (JP)

(72) Inventor: Kazunori MIYAKE, Kitakatsuragi-gun (JP)

(73) Assignee: JTEKT CORPORATION, Osaka (JP)

(21) Appl. No.: 13/590,654

(22) Filed: Aug. 21, 2012

(30) Foreign Application Priority Data
Aug. 31, 2011 (JP) 2011-189311

(51) Int. Cl. E05D 15/06; C08L 61/20; C08K 3/04; C08G 12/00

(52) U.S. Cl. 16/88; 528/229; 524/592

(57) ABSTRACT

A roller is essentially consisting of a resin composition that contains, as a base resin, a copolymer essentially consisting of a repeating unit expressed by a formula (i):

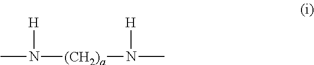

where “a” denotes a number from 4 to 9, a repeating unit expressed by a formula (ii):

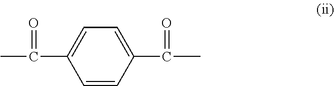

and a repeating unit expressed by a formula (iii):

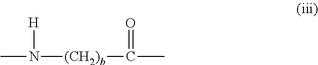

where “b” denotes a number from 9 to 11, the roller being formed in an annular shape. In a roller device, the roller is arranged to cover an outer periphery of an outer ring of a rolling bearing that includes an inner ring, the outer ring, and rolling elements.

### INCORPORATION BY REFERENCE

The disclosure of Japanese Patent Application No. 2011-189311 filed on Aug. 31, 2011 including the specification, drawings and abstract, is incorporated herein by reference in its entirety.

### BACKGROUND OF THE INVENTION

1. Field of the Invention

The invention relates to a roller device that guides a sliding door for opening and closing a doorway of, for example, a passenger vehicle along a guide rail, and a resin roller incorporated in the roller device.

2. Description of Related Art

In recent years, instead of an ordinary hinged door or in combination with an ordinary hinged door, a sliding door has been widely used in not only vans, in which sliding doors are conventionally employed, but also various types of vehicles such as standard-sized passenger vehicles and compact passenger vehicles. The sliding door is opened and closed to open and close a doorway (an opening through which an occupant gets on and off a vehicle) formed at a lateral side of a vehicle body. The doorway is closed by closing the sliding door. The doorway is opened by pulling the sliding door laterally outward from the vehicle body and then sliding the sliding door parallel with the vehicle body. A sliding door has advantages that the sliding door provides larger entrance or exit than ordinary hinged doors and the sliding door does not require a large space even when it is opened.

A roller device is used to guide the sliding door to open and close the doorway as described above. The roller device rolls on a guide rail arranged at a vehicle body to guide the sliding door. As the roller device, there is usually employed a roller device that includes a rolling bearing which includes an inner ring, an outer ring and rolling elements arranged between the inner ring and the outer ring, and of which the inner ring is fitted to the sliding door.

Preferably, a resin roller that constitutes an outer peripheral surface that rolls on the guide rail is provided on the outer ring so as to cover the outer periphery of the outer ring. Providing such a resin roller makes it possible to open and close the sliding door more quietly. The roller is generally formed of a resin composition that contains a general-purpose aliphatic nylon, for example, nylon 46 and nylon 66 that have high abrasion resistance, as a base resin.

However, if a roller of a roller device that may be exposed to the outside of the vehicle when a sliding door is opened, such as a roller device incorporated in a center roller portion that guides the sliding door at its middle portion in the door-height direction, is formed of a resin composition that contains the above-described aliphatic nylon, the following problem may arise. When the roller contacts, for example, rain water in an exposed state, the roller absorbs water and swells and the size of the roller significantly changes because the aliphatic nylon has high water absorbency. This may increase the torque that is required to open and close the sliding door.

In addition, aliphatic nylons have low resistance to calcium chloride that is contained in sea water or that is used as a snow-melting agent for a road. When an aliphatic nylon contacts the calcium chloride, the aliphatic nylon deteriorates and, for example, the strength of the aliphatic nylon is significantly reduced. Among aliphatic nylons, for example, nylon 11 and nylon 12 are lower in water absorbency than the above-described nylon 46 and nylon 66, and exhibit high resistance to calcium chloride. However, the above-described nylon 11 and the nylon 12 have low creep resistance.

In order to maintain color uniformity between the sliding door and a vehicle body, preferably, the sliding door is subjected to bake coating together with the vehicle body after the roller device is incorporated in the sliding door and the sliding door is fitted to the vehicle body. Therefore, the roller is required to have high creep resistance so that the roller is not creep-deformed even under the weight of the sliding door at the time of baking. However, the roller that contains nylon 11, nylon 12, or the like, as a base resin does not have such high creep resistance that it is able to withstand the baking and is therefore thermally deformed largely. Therefore, the roller device that includes such a roller should not be incorporated into the sliding door that is supposed to be subjected to bake coating.

Aromatic nylons, such as nylon 9T and nylon 6T, are lower in water absorbency and higher in resistance to calcium chloride than nylon 46, nylon 66, and the like, and are higher in creep resistance than nylon 11, nylon 12, and the like, among aliphatic nylons. However, aromatic nylons are lower in abrasion resistance than the various aliphatic nylons. Therefore, if a roller is formed of a resin composition that contains such an aromatic nylon as a base resin, the surface of the roller significantly abrades or peels off due to repetition of rolling. This may make it difficult to smoothly open or close the sliding door.

Therefore, making a roller from a nylon alloy formed of an aliphatic nylon and an aromatic nylon has been studied (see Japanese Patent Application Publication No. 2007-315483 (JP 2007-315483 A), Japanese Patent Application Publication No. 2006-138334 (JP 2006-138334 A), Japanese Patent No, 4357154, etc.). However, the aliphatic nylon and the aromatic nylon are not completely compatibilized in the nylon alloy but form a so-called see-island structure, so the crystallinity tends to be low. Therefore, particularly, when the roller slides over the guide rail under high contact pressure, there arises a problem that the effect of improving abrasion resistance is not obtained. When the sliding door is opened and closed, the roller of the roller device not only rolls on the guide rail but also slides with respect to the rail while rolling, and therefore the roller may slide under high contact pressure as described above.

In addition, there is also a problem that the roller formed of a nylon alloy of an aliphatic nylon and an aromatic nylon is lower in creep resistance than aromatic nylon.

### SUMMARY OF THE INVENTION

It is an object of the invention to provide a resin roller that has low water absorbency, high resistance to calcium chloride, high creep resistance and high abrasion resistance, and a roller device in which the roller is incorporated.

An aspect of the invention relates to a roller, essentially consisting of a resin composition that contains, as a base resin, a copolymer essentially consisting of a repeating unit expressed by a formula (i):

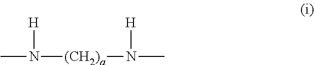

where “a” denotes a number from 4 to 9, a repeating unit expressed by a formula (ii):

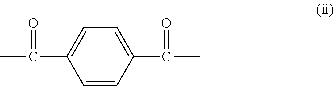

and a repeating unit expressed by a formula (iii):

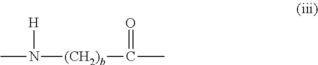

where “b” denotes a number from 9 to 11, the roller being formed in an annular shape, With this configuration, by forming the roller in an annular shape from the resin composition that contains the copolymer as the base resin, it is possible to obtain the roller that has low water absorbency, high resistance to calcium chloride, high creep resistance and high abrasion resistance.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view that shows an example of a roller device according to an embodiment of the invention;

FIG. 2 is a perspective view that schematically shows a sliding door in which the roller device is incorporated in a center roller portion;

FIG. 3 is an enlarged perspective view of main portions of the center roller portion; and

FIG. 4 is a perspective view that illustrates a test method for an abrasion resistance test carried out to evaluate abrasion resistance of resin compositions in examples of the invention and comparative examples.

### DETAILED DESCRIPTION OF EMBODIMENTS

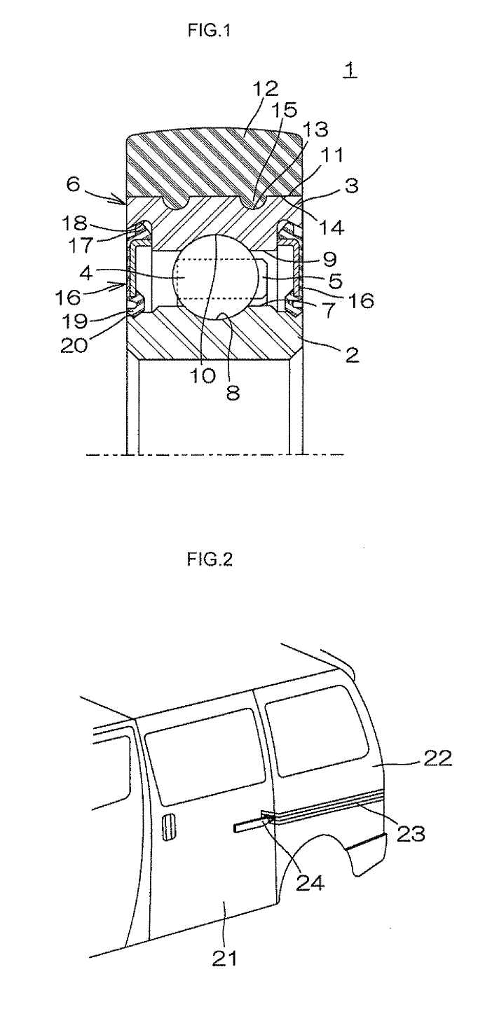

FIG. 1 is a sectional view that shows an example of a roller device according to an embodiment of the invention. As shown in FIG. 1, the roller device 1 in this example includes a rolling bearing 6. The rolling bearing 6 includes an inner ring 2, an outer ring 3, a plurality of balls 4, and a cage 5. The balls 4 are rolling elements that are arranged between the inner ring 2 and the outer ring 3. The cage 5 holds the balls 4 between the inner ring 2 and the outer ring 3 at substantially equal intervals.

The inner ring 2 is made of, for example, bearing steel, and formed in an annular shape. An annular raceway groove 8 is formed in an outer periphery 7 of the inner ring 2 at the center in the widthwise direction of the inner ring 2. The raceway groove 8 is recessed radially inward from the outer periphery 7. The raceway groove 8 forms a raceway on which the balls 4 roll. Similarly, the outer ring 3 is made of, for example, bearing steel, and formed in an annular shape. An annular raceway groove 10 is formed in an inner periphery 9 of the outer ring 3 at the center in the widthwise direction of the outer ring 3. The raceway groove 10 is recessed radially outward from the inner periphery 9. The raceway groove 10 forms a raceway on which the balls 4 roll.

A roller 12 is arranged on an outer periphery 11 of the outer ring 3 so as to cover the whole circumference of the outer periphery 11. The outer ring 3 and the roller 12 are assembled together by engaging annular convex projections 15 with annular concave grooves 13. The annular concave grooves 13 are recesses that are formed in the outer periphery 11 at two portions (in the drawing) in the widthwise direction, so as to extend radially inward. The annular convex projections 15 are projections that are formed on an inner periphery 14 of the roller 12 at portions corresponding to the concave grooves 13, so as to extend radially inward.

The outer ring 3 and the roller 12 are assembled together through, for example, so-called insert molding. In the insert molding, first, the rolling bearing 6 is set in a die having a cavity that corresponds to the outer shape of the roller 12, and then a resin composition that is the material of the roller 12 is poured into the cavity. Annular seal grooves 18 are formed on respective sides of the raceway groove 10 in the inner periphery 9 of the outer ring 3 so as to be parallel to the raceway groove 10. Base portions 17 of seals 16 that provide sealing between the inner ring 2 and the outer ring 3 are fixedly fitted in the seal grooves 18. Thus, the seals 16 are fixed in the seal grooves 18.

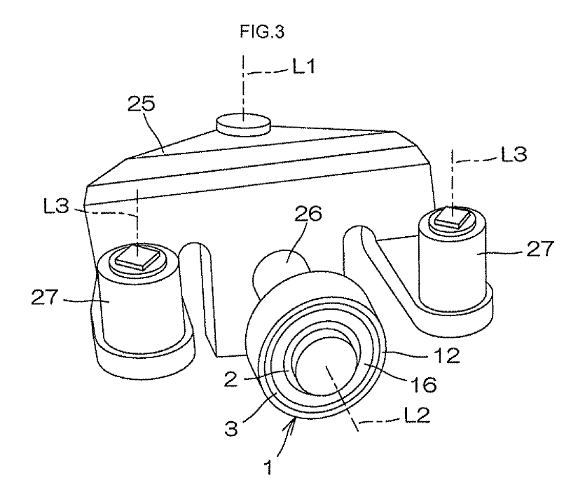

In addition, annular grooves 19 are formed on respective sides of the raceway groove 8 in the outer periphery 7 of the inner ring 2 so as to be parallel to the raceway groove 8. Distal ends of seal lips 20 of the seals 16 are fitted in the respective grooves 19. Thus, the seals 16 provide sealing between inner ring 2 and the outer ring 3. FIG. 2 is a perspective view that schematically shows a sliding door in which the roller device is incorporated in a center roller portion. FIG. 3 is an enlarged perspective view of main portions of the center roller portion.

As shown in FIG. 2 and FIG. 3, the roller device 1 in this example is suitably incorporated in the center roller portion 24. The center roller portion 24 is used to guide, for example, the sliding door 21 at its middle portion in the door height direction, along a guide rail 23 provided on the outer face of a vehicle body 22. The center roller portion 24 includes a head 25. The head 25 is provided so as to be pivotable in a substantially horizontal direction with respect to the sliding door 21, about the central axis L1 that extends in a direction substantially perpendicular to the longitudinal direction of the guide rail 23.

In addition, the head 25 includes a support shaft 26 of which the central axis L2 extends in a direction perpendicular to the central axis L1. The inner ring 2 of the roller device 1 is fitted to the support shaft 26. Thus, the outer ring 3 and roller 12 of the roller device 1 are supported by the head 25 so as to be rotatable about the central axis L2. The outer ring 3 and the roller 12 of the roller device 1 roll on the guide rail 23. Thus, the roller device 1 functions to open and close the slide door 21 while supporting the slide door 21. The roller device 1 is used to switch the state of the sliding door 21 between a state where the sliding door 21 closes a doorway formed at a lateral side of the vehicle body as shown in FIG. 2 and a state (not shown) where the doorway is opened by pulling the sliding door 21 laterally outward in the vehicle width direction and moving the sliding door 21 parallel with the vehicle body.

A pair of auxiliary rollers 27 is provided. The auxiliary rollers 27 are provided on respective sides of the roller device 1. Each of the auxiliary rollers 27 is provided such that the central axis L3 of the auxiliary roller 27 extends parallel with the central axis L1. The auxiliary rollers 27 roll while being in contact with the inner surface (not shown) of the guide rail 23. In this way, each auxiliary roller 27 functions as a latch of the sliding door 21.

### Resin Composition

The roller 12 of the roller device 1 is formed of a resin composition that contains, as a base resin, a copolymer formed of a repeating unit expressed by the formula (i):

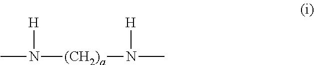

where “a” denotes a number from 4 to 9, a repeating unit expressed by the formula (ii):

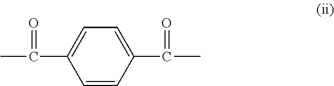

and a repeating unit expressed by the formula (iii):

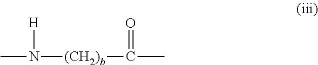

where “b” denotes a number from 9 to 11, and is formed in an annular shape as described above. The copolymer is formed of the repeating units respectively expressed by the formulas (i) and (ii), corresponding to aromatic nylons, such as nylon 6T and nylon 9T, and the repeating unit expressed by the formula (iii), corresponding to nylon 11, nylon 12, or the like, among aliphatic nylons. Therefore, the copolymer is remarkably lower in water absorbency and higher in resistance to calcium chloride than nylon 46, nylon 66, and the like.

In addition, the copolymer has high creep resistance equivalent to that of the aromatic nylons owing to the action of the repeating units expressed by the formulas (i) and (ii), and also has high abrasion resistance equivalent to or higher than aliphatic nylons owing to the action of the repeating unit expressed by the formula (iii). Therefore, the roller is formed of a resin composition that basically contains only the copolymer as a base resin, and the formed roller exhibits a homogeneous phase and does not form a sea-island structure unlike a nylon alloy of an aliphatic nylon and an aromatic nylon. Therefore, it is possible to prevent a decrease in the abrasion resistance and creep resistance due to a decrease in the crystallinity.

Thus, by forming the roller 12 in an annular shape from a resin composition that contains the copolymer as a base resin, it is possible to obtain the roller 12 that has low water absorbency, high resistance to calcium chloride, high creep resistance and high abrasion resistance. Particularly, the copolymer is preferably formed of a repeating unit expressed by the formula (iv):

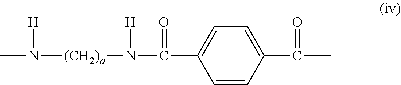

where “a” denotes a number from 4 to 9 and a repeating unit expressed by the formula (iii):

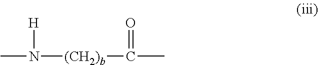

where “b” denotes a number from 9 to 11. The copolymer has the repeating unit expressed by the formula (iv) corresponding to an aromatic nylon, such as nylon 6T and nylon 9T, that links the repeating units expressed by the above-described formulas (i) and (ii). Therefore, the copolymer is able to further appropriately exhibit high creep resistance provided by the aromatic nylon.

The quantitative ratio between the repeating unit expressed by the formula (iv) and the repeating unit expressed by the formula (iii) in the copolymer is not specifically limited, but it is preferably from 60/40 to 70/30 in mass ratio of Wᵢᵥ/Wᵢᵢᵢ. When the percentage of the repeating unit expressed by the formula (iv) is lower than the lower limit of the above range (60%), there is a possibility that the effect of maintaining the creep resistance of the roller 12, provided by this repeating unit, will not be obtained. On the other hand, when the percentage of the repeating unit expressed by the formula (iii) is lower than the lower limit of the above range (30%), there is a possibility that the effect of improving the abrasion resistance of the roller 12, provided by this repeating unit, will not be obtained.

The copolymer is not specifically limited to this, but it may be, for example, Biroamide™ MJ-300 produced by Toyobo, Co., Ltd., where “a” in the formula (iv) is 6, “b” in the formula (iii) is 10 and the mass ratio Wᵢᵥ/Wᵢᵢᵢ is 60/40. As described above, basically, it is preferable that single type of the copolymer be solely used as a base resin in terms of forming a homogeneous phase without forming a sea-island structure and simplification of configuration.

However, two or more types of copolymers having different mass ratios Wᵢᵥ/Wᵢᵢᵢ may be used together to adjust the mass ratio Wᵢᵥ/Wᵢᵢᵢ of a base resin as a whole. In addition, particularly, one type of nylon selected from other nylons that have high compatibility with the copolymer and that do not cause a sea-island structure may be used as a base resin. Also, two or more types of nylons selected from other nylons that have high compatibility with the copolymer and that do not cause a sea-island structure may be used as a base resin. The resin composition may contain reinforced fiber as in related art.

The reinforced fiber may be one type of fiber or two or more types of fibers selected from, for example, glass fiber, carbon fiber, fiber wollastonite, silicon carbide fiber, boron fiber, alumina fiber, Si—Ti—C—O fiber, metal fiber (e.g. copper, steel, stainless steel), aromatic polyamide (aramid) fiber, potassium titanate whisker, graphite whisker, silicon carbide whisker, silicon nitride whisker and alumina whisker.

Particularly, carbon fiber that has a beneficial effect of improving the abrasion resistance and creep resistance of the roller is preferably employed. The compound percentage of carbon fiber with respect to the entirety of the resin composition is preferably higher than or equal to 25% by mass and is lower than or equal to 40% by mass. If the compound percentage is lower than the lower limit of the above range (25%), there is a possibility that the effect of improving the abrasion resistance and creep resistance of the roller, provided by mixing carbon fiber, will not be sufficiently obtained. In addition, when the compound percentage exceeds the upper limit of the above range (40%), it may be difficult to compound and mix components in order to prepare the resin composition.

Various known additives, such as an impact reforming agent and a coloring agent, for example, polyolefin or elastomer, may be compounded with the resin composition at a given percentage where necessary.

### First Example

Carbon fiber that serves as reinforced fiber was compounded with a base resin that is a copolymer formed of the repeating unit expressed by the formula (iv) and the repeating unit expressed by the formula (iii) and that is formed such that “a” in the formula (iv) is 6, “b” in the formula (iii) is 10 and the mass ratio Wᵢᵥ/Wᵢᵢᵢ is 70/30 to prepare the resin composition. The compound percentage of carbon fiber with respect to the entirety of the resin composition was 30% by mass.

### Second Example

The resin composition was prepared as in the case of the first example except that a base resin is a copolymer formed of the repeating unit expressed by the formula (iv) and the repeating unit expressed by the formula (iii) and is formed such that “a” in the formula (iv) is 6, “b” in the formula (iii) is 10 and the mass ratio Wᵢᵥ/Wᵢᵢᵢ is 60/40.

### First Comparative Example

The resin composition was prepared as in the case of the first example except that nylon 46 (PA46) was used as a base resin.

### Second Comparative Example

The resin composition was prepared as in the case of the first example except that nylon 6T (PA6T) was used as a base resin.

### Third Comparative Example

The resin composition was prepared as in the case of the first example except that nylon 11 (PA11) was used as a base resin.

Measurement of Deflection Temperature under Load

The resin compositions prepared in the examples and comparative examples were used to prepare specimens defined in Japan Industrial Standards JIS K7191-1_{:2007} (ISO75-1_{:2004}) Plastics-Determination of temperature of deflection under load—Part 1: General test method”, and deflection temperatures under load were measured in conformity with method A (load 1.8 MPa) written in the above Standards and JIS K7191-2_{:2007} (ISO75-2_{:2004}) “Plastics-Determination of temperature of deflection under load—Part 2: Plastics and ebonite” to thereby evaluate creep resistances.

### Measurement of Water Absorption Ratio

The resin compositions prepared in the first example and first comparative example among the examples and comparative examples were used to prepare specimens defined in Japan Industrial Standards JIS K7209: 2000 (IS62: 1999) “Plastics-Determination of water absorption”, and water absorption amounts were measured in conformity with method D written in the Standards to thereby evaluate water absorbencies.

### Abrasion Resistance Test

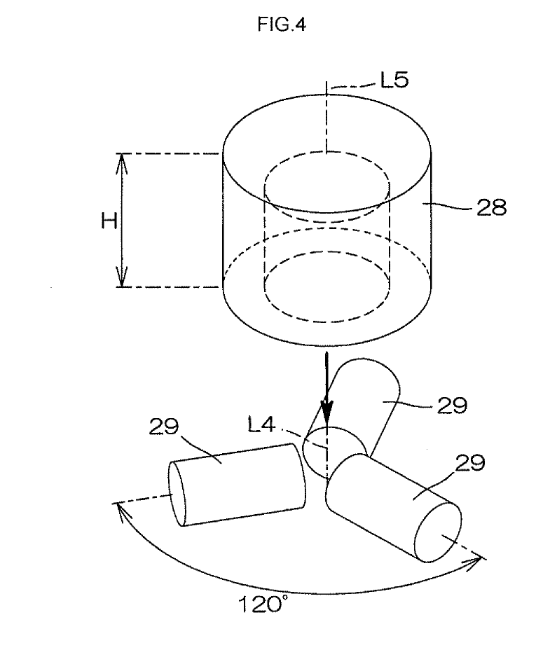

The resin compositions prepared in the examples and comparative examples were used to prepare specimens 28 having a closed end cylindrical shape, an outside diameter of 25 mm and an inside diameter of 15 mm as shown in FIG. 4. On a flat bed, each specimen 28 was brought into contact with three steel rollers 29 that are non-rotatably fixed at equal angular intervals of 120° about the central axis L4 such that the central axis L5 coincides with the central axis L4 with the open side of the specimen 28 oriented downward, as indicated by the thick arrow in the drawing.

Subsequently, while the specimen 28 was pushed against the rollers 29 under a contact pressure of 200 N, the specimen 28 was continuously rotated about the central axis L5 for ten seconds at a rotation speed of 0.5 m/s, and then stopped for ten seconds. This operation was continuously performed over two hours, and then an amount of change in the height H of the specimen 28 was measured as the amount of abrasion to thereby evaluate abrasion resistance. The amount of abrasion is indicated by a positive value (+) when the height H is reduced, and is indicated by a negative value (−) when the height H is increased. The height H of the specimen 28 in the third comparative example was increased as shown in Table 1 shown below. This is presumably due to thermal expansion, or the like. The specimen in the second comparative example was melted and broken during the test, so the height H was not measured.

The above results are shown in Table 1.

TABLE 1

| | | | | Comparative | Comparative | Comparative |
|---|---|---|---|---|---|---|
| | | Example 1 | Example 2 | Example 1 | Example 2 | Example 3 |
| Base | Type | Copolymer | Copolymer | PA46 | PA6T | PA11 |
| Resin | Wᵢᵥ/Wᵢᵢᵢ | 70/30 | 60/40 | — | — | — |
| Evaluation | Deflection | 282 | 280 | 280 | 290 | 54 |
| | Temperature | | | | | |
| | under Load | | | | | |
| | (° C.) | | | | | |
| | Water | 0.9 | — | 3.1 | — | — |
| | Absorption | | | | | |
| | Ratio (%) | | | | | |
| | Amount of | 0.096 | 0.081 | 0.129 | Not | −0.012 |
| | Abrasion | | | | measured | |
| | (mm) | | | | | |

From the results of Table 1, it was found that, when the copolymer formed of the repeating units expressed by the formulas (iii) and (iv) is used as a base resin, it is possible to improve creep resistance while suppressing water absorbency and maintaining high abrasion resistance as compared with the existing nylon 46.

According to the invention, it is possible to provide a resin roller that has low water absorbency, high resistance to calcium chloride, high creep resistance and high abrasion resistance, and a roller device in which the roller is incorporated.

What is claimed is:

1. A roller, essentially consisting of:
a resin composition that contains, as a base resin, a copolymer essentially consisting of a repeating unit expressed by a formula (i): 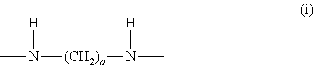
where “a” denotes a number from 4 to 9, a repeating unit expressed by a formula (ii): 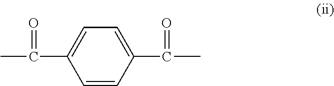
and a repeating unit expressed by a formula (iii): 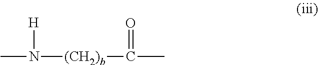
where “b” denotes a number from 9 to 11, the roller being formed in an annular shape.

2. The roller according to claim 1, wherein the copolymer contains a repeating unit expressed by a formula (iv): 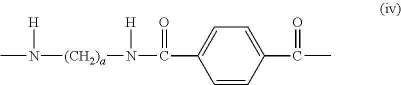
where “a” denotes a number from 4 to 9 and a repeating unit expressed by the formula (iii): 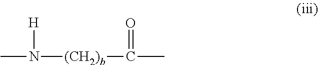
where “b” denotes a number from 9 to 11.

3. The roller according to claim 1, wherein the resin composition contains carbon fiber, wherein a compound percentage of the carbon fiber with respect to an entirety of the resin composition is higher than or equal to 25% by mass and lower than or equal to 40% by mass.

4. The roller according to claim 2, wherein the resin composition contains carbon fiber, wherein a compound percentage of the carbon fiber with respect to an entirety of the resin composition is higher than or equal to 25% by mass and lower than or equal to 40% by mass.

5. A roller device, comprising:
a rolling bearing that includes an inner ring; an outer ring, and rolling elements arranged between the inner ring and the outer ring; and
the roller according to claim 1,
wherein the roller is arranged so as to cover an outer periphery of the outer ring of the rolling bearing.

6. A roller device, comprising:
a rolling bearing that includes an inner ring; an outer ring, and rolling elements arranged between the inner ring and the outer ring; and
the roller according to claim 2,
wherein the roller is arranged so as to cover an outer periphery of the outer ring of the rolling bearing.

7. A roller device, comprising:
a rolling bearing that includes an inner ring; an outer ring, and rolling elements arranged between the inner ring and the outer ring; and
the roller according to claim 3,
wherein the roller is arranged so as to cover an outer periphery of the outer ring of the rolling bearing.

8. A roller device, comprising:
a rolling bearing that includes an inner ring; an outer ring, and rolling elements arranged between the inner ring and the outer ring; and
the roller according to claim 4,
wherein the roller is arranged so as to cover an outer periphery of the outer ring of the rolling bearing.
